(19) United States
(12) Patent Application Publication
(10) Pub. No.: US 2016/0171448 A1
(43) Pub. Date: Jun. 16, 2016

(54) Method of Job Recruiting between an Employer Network and a Jobseeker Network

(71) Applicant: Mark Jeffrey Stevens, Deer Park, NY (US)

(72) Inventor: Mark Jeffrey Stevens, Deer Park, NY (US)

(21) Appl. No.: 14/970,530

(22) Filed: Dec. 15, 2015

Related U.S. Application Data
(60) Provisional application No. 62/091,671, filed on Dec. 15, 2014.

(51) Int. Cl. G06Q 10/10

(52) U.S. Cl. CPC G06Q 10/1053

(57) ABSTRACT

Disclosed is a method of job recruiting between an employer network and a jobseeker network.

The current application claims a priority to the U.S. Provisional Patent application serial number 62/091,671 filed on Dec. 15, 2014.

### FIELD OF THE INVENTION

The present invention relates generally to a method for online recruiting. More specifically, the present invention is a web-based system and portal for recruiting for professional service industries.

### BACKGROUND OF THE INVENTION

Currently, there are many websites that provide a means for connecting recruiters and jobseekers such as Monster.com, and CareerBuilder. Companies use these sites to post open positions for hiring, and jobseekers use these sites to look for and apply to positions of interest. However, online job boards such as those mentioned above provide a very limited pre-qualification process. Thus, matching criteria such as job requirements and jobseeker qualifications can be difficult and cumbersome for employers to measure. It is therefore an object of the present invention to provide a web-based system and portal for recruiting which utilizes a unique process to match jobseekers to employers, as well as to match job descriptions to each jobseekers specific background in a significantly more comprehensive manner than is presently available.

### BRIEF DESCRIPTION OF THE DRAWINGS

FIG. 1 through 10 illustrate the present invention.

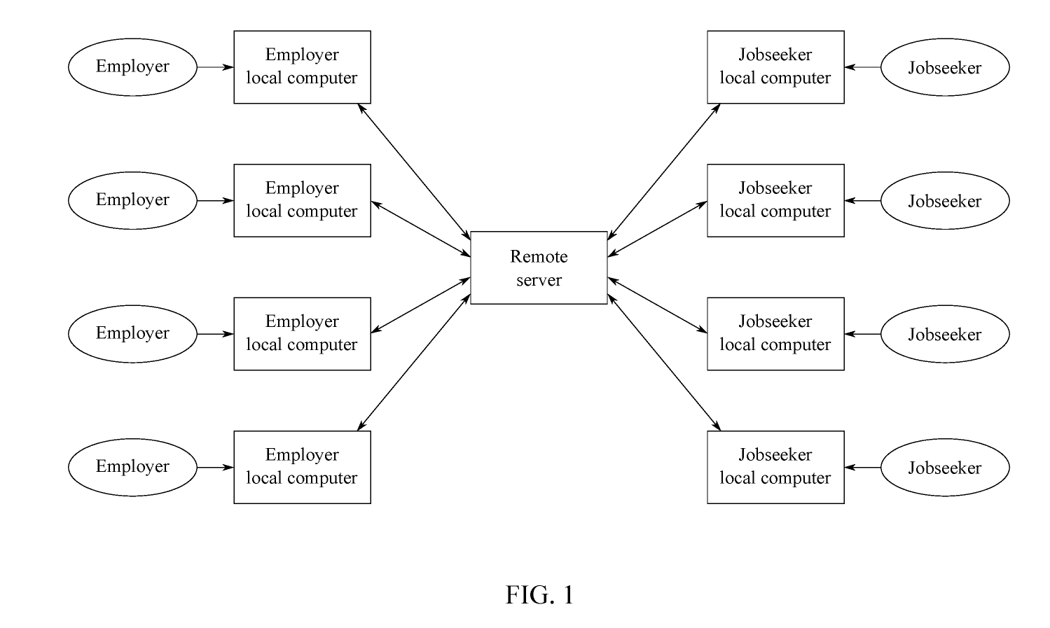

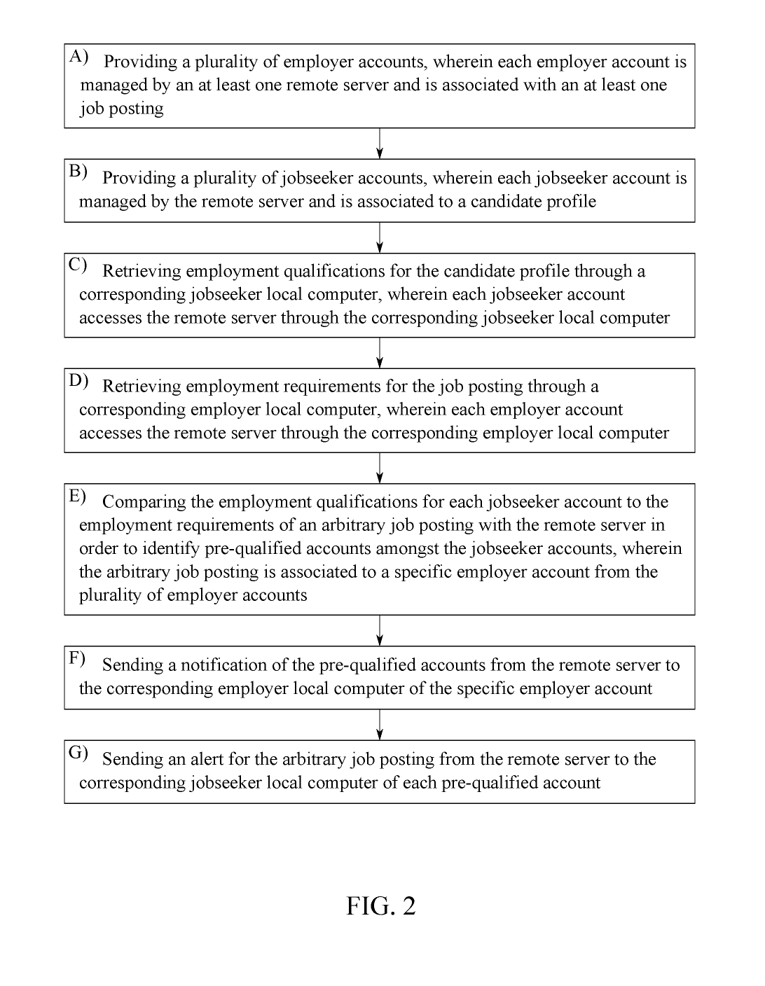

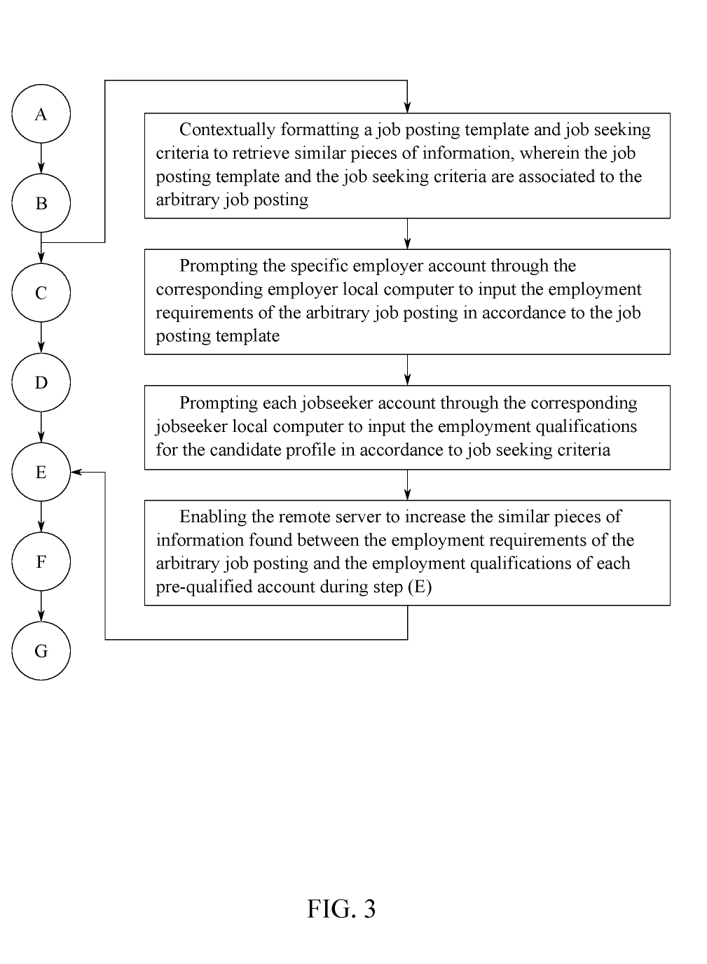

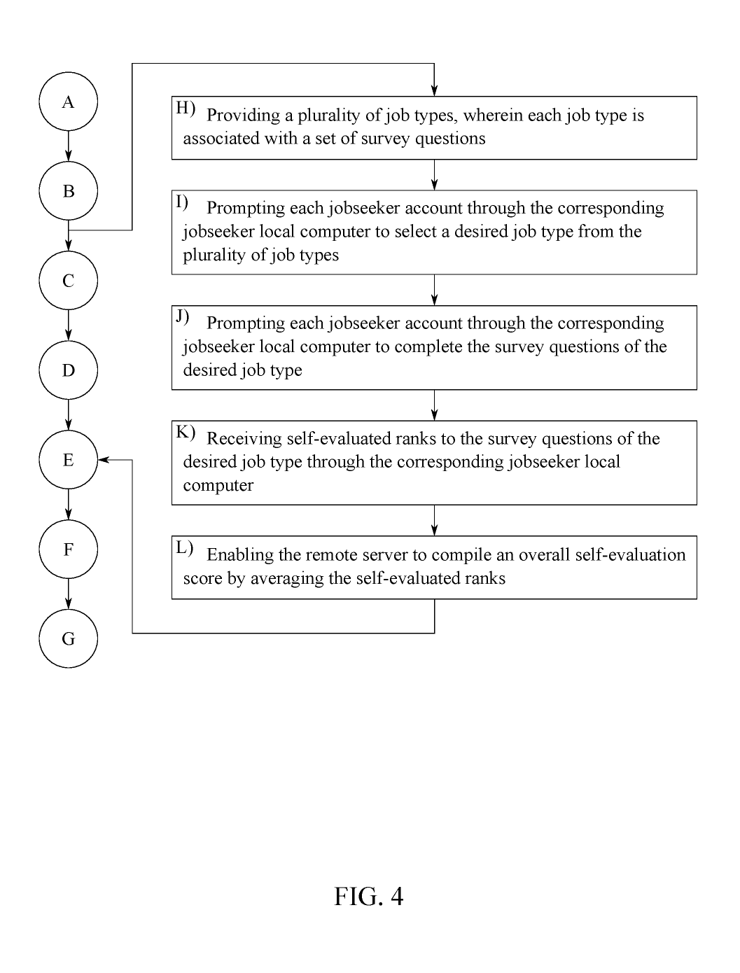

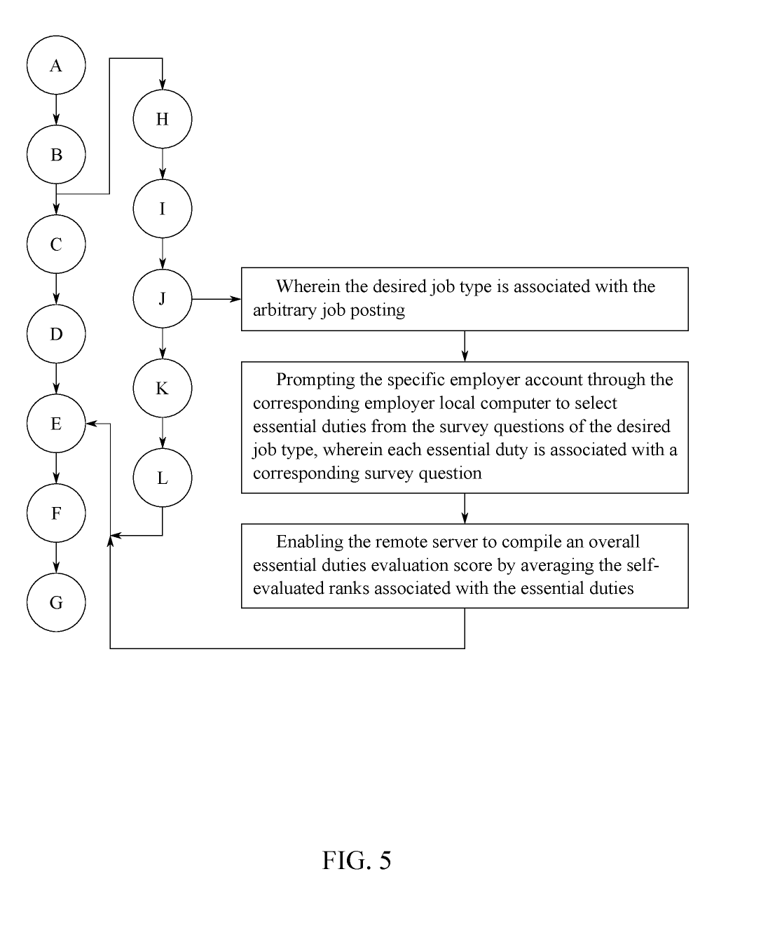

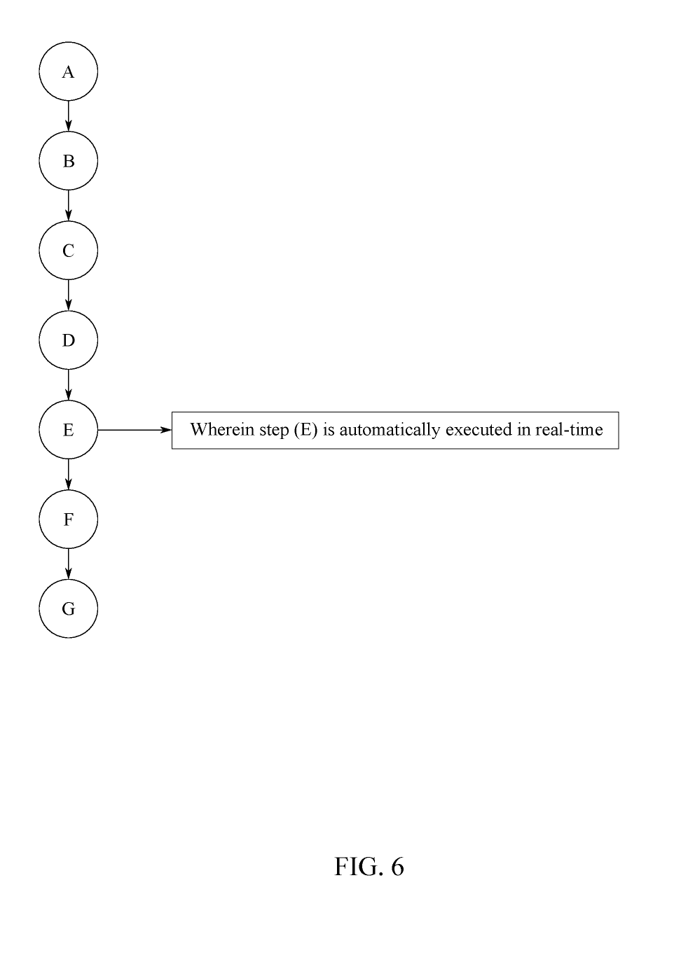

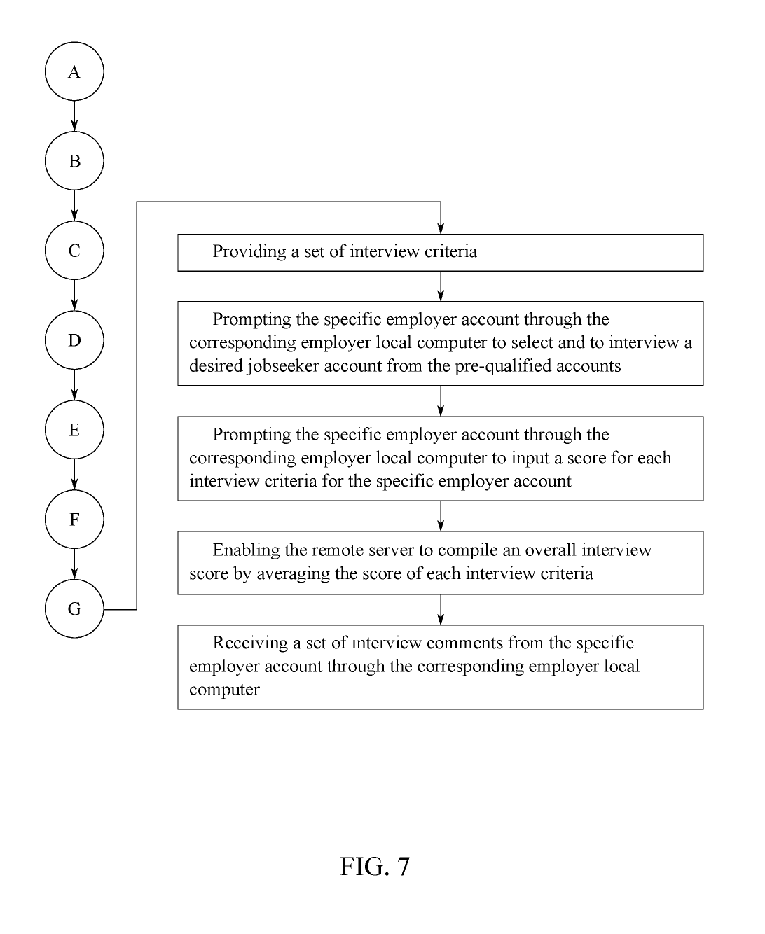

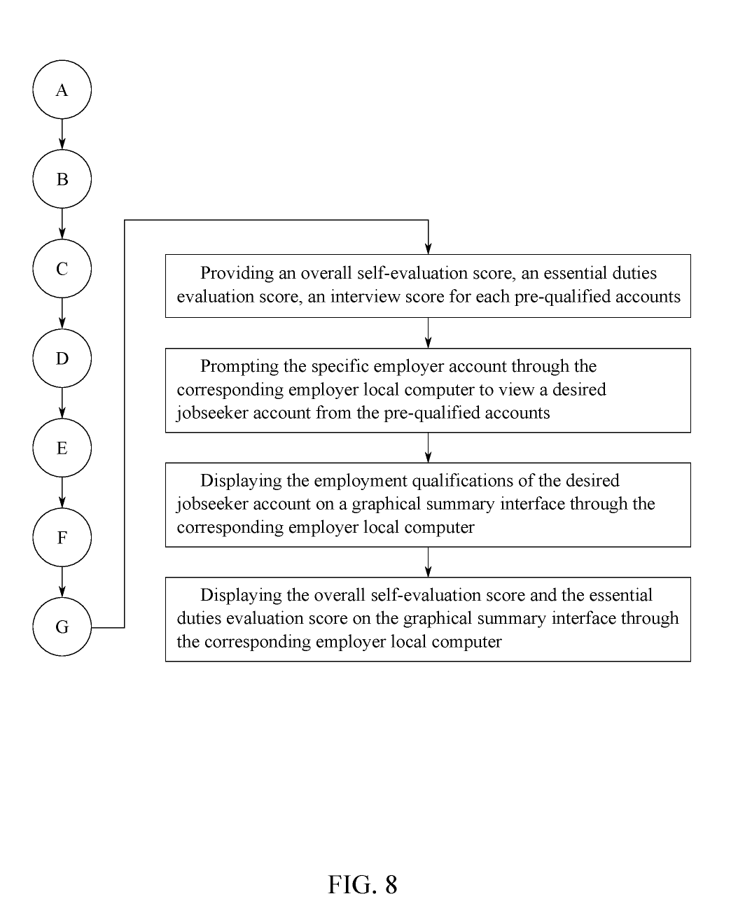

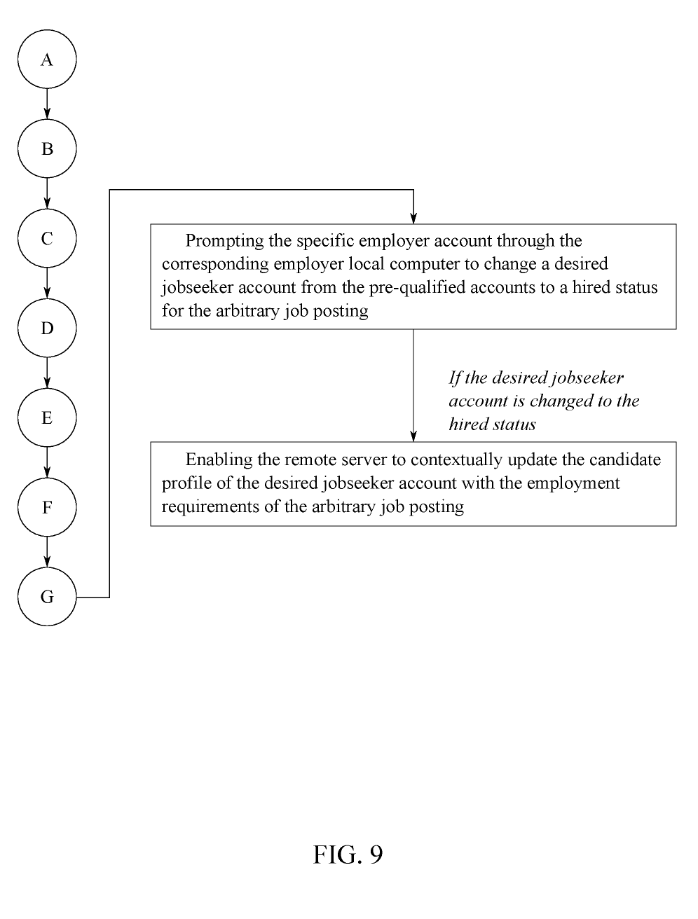

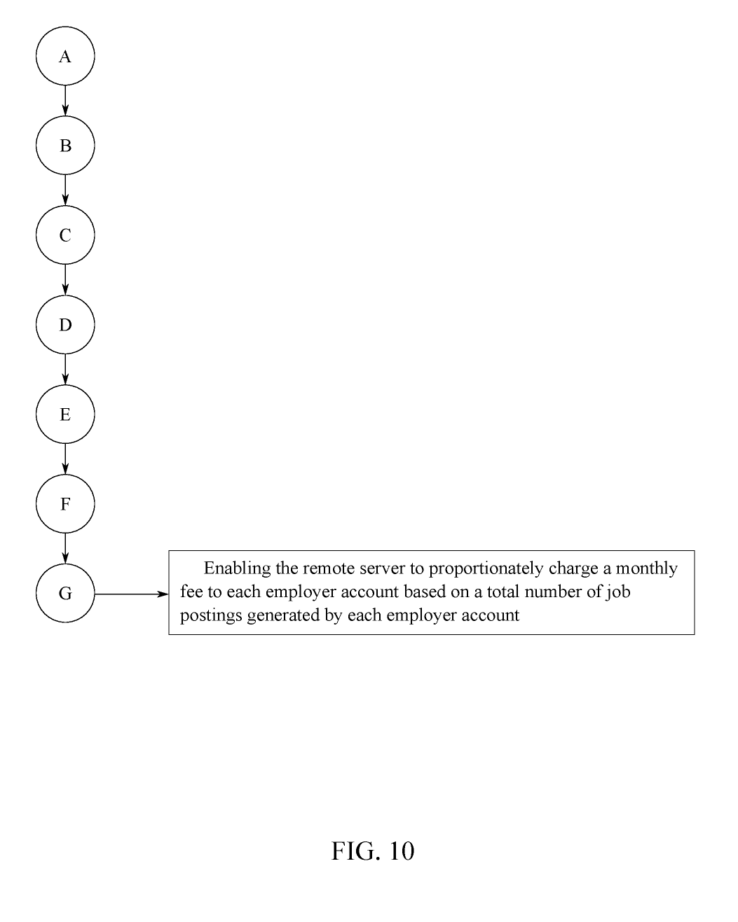

### DETAILED DESCRIPTION OF THE INVENTION

All illustrations of the drawings are for the purpose of describing selected versions of the present invention and are not intended to limit the scope of the present invention.

The present invention is method job recruiting between an employer network and a jobseeker network. The present invention is preferably designed as an Internet- or web-based system and portal. The employer network allows users that are employers within the job recruiting business to communicate and to access the present invention. Similarly, the jobseeker network allows users that are looking for job opportunities to communicate and to access the present invention. The present invention allows users within the employer network to find a better match of users within the jobseeker network through a comprehensive pre-qualification process.

The system used to execute the method of the present invention allows the present invention to interconnect a large number of users with a vast range of expertise. The system includes at least one remote server, which is used to manage interactions between the employer network and the jobseeker network and is used to execute some internal processes of the present invention. The remote server is able to identify the users that are employers as a plurality of employer accounts, and, thus, the remote server manages each employer account (Step A). An employer account is created on the present invention so that a user can submit at least one job posting on the present invention. The job posting describes a job opportunity that needs to be filled by an employee. Likewise, the remote server is able identify the users that are looking for job opportunities as a plurality of jobseeker accounts, and, thus, the remote server manages each jobseeker account (Step B). A jobseeker account is created on the present invention so that a user can be alerted to new job openings and be recruited by users within the employer network. Each jobseeker account is associated with a candidate profile, which includes information that is typically found on a professional résumé.

The overall process followed by the method of the present invention allows users within the employer network to find better-matching, pre-qualified users within the jobseeker network. The overall process begins by retrieving employment qualifications for any candidate profile through a corresponding jobseeker local computer (Step C). The employment qualifications describes a user's career experiences, professional abilities, certifications, or any information that could attract potential employers. The corresponding jobseeker local computer is any kind of computing device that allows the user of each jobseeker account to communicate and access the remote server. The overall process continues by retrieving employment requirements for any job posting through a corresponding employer local computer (Step D). The employment requirements describes the necessary professional requirements of anyone that applies to the job opening. The corresponding employer local computer is any kind of computing device that allows the user of each employer account to communicate and access the remote server. The corresponding jobseeker local computer and the corresponding employer local computer can be, but is not limited to, a smartphone, a tablet personal computer, a laptop, or a desktop and are used create a vast communication network between potential employers and jobseekers through the remote server.

Thereafter, the present invention compares the employment qualifications for each jobseeker account to the employment requirements of an arbitrary job posting with the remote server in order to identify pre-qualified accounts amongst the jobseeker accounts (Step E). The pre-qualified accounts are identified by the remote server because the employment qualifications of the pre-qualified accounts and the employment requirements of the arbitrary job posting share enough common items to be conspicuously recognized by the remote server. The arbitrary job posting is defined as any job posting that is uploaded by any employer account onto the present invention. However, the arbitrary job posting is always associated to a specific employer account from the plurality of employer account so that the specific employer account is known by the present invention to have originated the arbitrary job posting. Step E is automatically executed by the remote server in real-time so that the jobseeker accounts have on-going access to new job postings.

The overall process concludes by notifying or alert the respective accounts about the results generated in Step E. The present invention sends a notification of the pre-qualified accounts from the remote server to the corresponding employer local computer of the specific employer account (Step F), which allows the user of the specific employer account to view and study the candidate profiles of the pre-qualified accounts. In addition, the present invention sends an alert for the arbitrary job posting from the remote server to the corresponding jobseeker local computer of each pre-qualified account (Step G) in order to make the user aware of the potential job opening. The alert for the arbitrary job posting is sent in real-time via email or text messaging.

One feature of the present invention that allows the remote server to find more accurate matches between job postings and candidate profiles is job posting templates and job seeking criteria. A job posting template describes the pieces of information that should be included into a job posting. Job seeking criteria describes the kind of job openings that a user is looking to find with the present invention. If a job posting template and job seeking criteria are both associated to an arbitrary job posting, then the present invention can contextually format the job posting template and the job seeking criteria to retrieve similar pieces of information. These similar pieces of information preferably include, but are not limited to, kind of industry, job type, job status, travel distance, salary range, industry experience, college degree, language requirements. Thus, the present invention prompts the specific employer account through the corresponding employer local computer to input the employment requirements of the arbitrary job positing in accordance to the job posting template. Similarly, the present invention prompts each jobseeker accounts through corresponding jobseeker local computer to input the employment qualifications for their candidate profile in accordance to the job seeking criteria. The end result is that the remote server is able to increase the similar pieces of information between the employment requirements of the arbitrary job posting and the employment qualifications of each pre-qualified account during Step E. This again allows the present invention to find more accurate matches between job postings and candidate profiles.

Another feature of the present invention that allows the remote server to find more accurate matches between job postings and candidate profiles is self-evaluation surveys. The present invention provides a plurality of job types, which allows the present invention to categorize different kinds of job opportunities. Each of the job types is associated with a set of survey questions, which are used to gather more information about the jobseeker. The process for successfully utilizing the self-evaluation surveys begins by prompting each jobseeker account through the corresponding jobseeker local computer to select a desired job type from the plurality of job types. The desired job type describes the kind of job opportunity that a job seeking user wants to find by using the present invention. This process continues by prompting each jobseeker account through the corresponding jobseeker local computer to complete the survey questions of the desired job type. The self-evaluated ranks to the survey questions of the desired job type are received through the corresponding jobseeker local computer. The self-evaluated ranks are preferably gathered as numerical values that are chosen from a range of 0 to 100 by the job seeking user. The process concludes by enabling the remote server to compile an overall self-evaluation score by averaging the self-evaluation ranks. The overall self-evaluation score allows a potential employer to complete a quick comparison of all of the job seeking users.

Moreover, the self-evaluation surveys can be used to find even better matches between job posting and candidate profiles by receiving input from potential employers. If the desired job type is associated with an arbitrary job posting, then present invention prompts the specific employer account through the corresponding employer local computer to select essential duties from the survey questions of the desired job type. Each essential duty is associated with a corresponding survey question and is thought by the potential employer to be an important indication of how well a job seeking user would be able to perform at the desired job type. The remote server is enabled to compile an overall essential duties evaluation score by averaging the self-evaluated ranks associated with the essential duties. The overall essential duties evaluation score should be a more accurate gauge than the overall self-evaluation score for how the potential employer wants the job seeking user to perform at the desired job type.

Another feature of the present invention that allows the remote server to find more accurate matches between job postings and candidate profiles is an interview process. The present invention is provided with a set of interview criteria that allow a potential employer to judge a job seeking user during the interview process. The interview criteria preferably include, but are not limited to, appearance, bearing, expression, job knowledge, motivation, and personality. The interview process begins by prompting the specific employer account through the corresponding employer local computer to select and to interview a desired jobseeker account from the pre-qualified accounts. The desired job seeker account is selected as which one of the pre-qualified accounts would be able to perform the best at the job opportunity according to the potential employer. In addition, the potential employer is associated to the specific employer account. As the potential employer is conducting the real-life interview for the job seeker user associated to the desired jobseeker account, the present invention prompts the specific employer account through the corresponding employer local computer to input a score for each interview criteria for the specific employer account. Similar to the self-evaluated ranks, the score for each interview criteria is preferably gathered as a numerical value that are chosen from a range of 0 to 100 by the potential employer. The interview process for the present invention continues by enabling the remote server to compile an overall interview score by averaging the score of each interview criteria, which allows the potential employer to view the entire interview process as a single numerical value. In addition, the present invention may also receive and record a set of interview comments from the specific employer account through the corresponding employer local computer. The interview comments made by the potential employer can be of any contextual nature.

Another feature of the present invention that allows the remote server to find more accurate matches between job postings and candidate profiles is a graphical summary interface. In order to use the graphical summary interface, the present invention needs to prompt the specific employer account through the corresponding employer local computer to view a desired jobseeker account from the pre-qualified accounts. Again, the desired jobseeker account is selected as which one of the pre-qualified accounts would be able to perform the best at the job opportunity according to the potential employer. The present invention then displays the employment qualifications, the overall self-evaluation score, and the essential duties evaluation score on the graphical summary interface through the corresponding employer local computer. The graphical summary interface allows the potential employer to view all of necessary information for the job seeker user associated to the desired jobseeker account into one single display.

Another feature of the present invention is a process to automatically update the candidate profile for a job seeking user after the job seeking user is hired for a job. This process begins by prompting the specific employer account through the corresponding employer local computer to change a desired jobseeker account from the pre-qualified accounts to a hired status for the arbitrary job posting. The hired status for the arbitrary job posting means that the arbitrary job posting is filled by the job seeking user associated to the desired jobseeker account. Once the desired jobseeker account is changed to the hired status, the remote server then contextually updates the candidate profile of the desired jobseeker account with the employment requirements of the arbitrary job posting so that the candidate profile shows that the job seeking user was hired by the potential employer.

Another feature of the present invention is to charge a monthly fee to the employers for using the present invention, which would prevent unnecessary commission increases. Thus, the remote server is enable to proportionately charge a monthly fee to each employer account based on a total number of job postings generated by each employer account. For example, if a first potential employer had 50 job postings per month on the present invention and a second potential employer had 100 job postings per month on the present invention, then the monthly fee of the second potential employer would be higher than the monthly fee of the first potential employer.

Although the invention has been explained in relation to its preferred embodiment, it is to be understood that many other possible modifications and variations can be made without departing from the spirit and scope of the invention as hereinafter claimed.

What is claimed is:

1. A method of job recruiting between an employer network and a jobseeker network, the method comprises the steps of:
(A) providing a plurality of employer accounts, wherein each employer account is managed by an at least one remote server and is associated with an at least one job posting;
(B) providing a plurality of jobseeker accounts, wherein each jobseeker account is managed by the remote server and is associated to a candidate profile;
(C) retrieving employment qualifications for the candidate profile through a corresponding jobseeker local computer, wherein each jobseeker account accesses the remote server through the corresponding jobseeker local computer;
(D) retrieving employment requirements for the job posting through a corresponding employer local computer, wherein each employer account accesses the remote server through the corresponding employer local computer;
(E) comparing the employment qualifications for each jobseeker account to the employment requirements of an arbitrary job posting with the remote server in order to identify pre-qualified accounts amongst the jobseeker accounts, wherein the arbitrary job posting is associated to a specific employer account from the plurality of employer accounts;
(F) sending a notification of the pre-qualified accounts from the remote server to the corresponding employer local computer of the specific employer account;
(G) sending an alert for the arbitrary job posting from the remote server to the corresponding jobseeker local computer of each pre-qualified account;

2. The method of job recruiting between an employer network and a jobseeker network, the method as claimed in claim 1 comprises the steps of:
contextually formatting a job posting template and job seeking criteria to retrieve similar pieces of information, wherein the job posting template and the job seeking criteria are associated to the arbitrary job posting;
prompting the specific employer account through the corresponding employer local computer to input the employment requirements of the arbitrary job posting in accordance to the job posting template;
prompting each jobseeker account through the corresponding jobseeker local computer to input the employment qualifications for the candidate profile in accordance to the job seeking criteria;
enabling the remote server to increase the similar pieces of information found between the employment requirements of the arbitrary job posting and the employment qualifications of each pre-qualified account during step (E);

3. The method of job recruiting between an employer network and a jobseeker network, the method as claimed in claim 2, wherein the job seeking criteria is selected from a group consisting of: kind of industry, job type, job status, travel distance, salary range, industry experience, college degree, language requirements, and combinations thereof.

4. The method of job recruiting between an employer network and a jobseeker network, the method as claimed in claim 1 comprises the steps of:
providing a plurality of job types, wherein each job type is associated with a set of survey questions;
prompting each jobseeker account through the corresponding jobseeker local computer to select a desired job type from the plurality of job types;
prompting each jobseeker account through the corresponding jobseeker local computer to complete the survey questions of the desired job type;
receiving self-evaluated ranks to the survey questions of the desired job type through the corresponding jobseeker local computer;
enabling the remote server to compile an overall self-evaluation score by averaging the self-evaluated ranks;

5. The method of job recruiting between an employer network and a jobseeker network, the method as claimed in claim 4 comprises the steps of:
wherein the desired job type is associated with the arbitrary job posting;
prompting the specific employer account through the corresponding employer local computer to select essential duties from the survey questions of the desired job type, wherein each essential duty is associated with a corresponding survey question;
enabling the remote server to compile an overall essential duties evaluation score by averaging the self-evaluated ranks associated with the essential duties;

6. The method of job recruiting between an employer network and a jobseeker network, the method as claimed in claim 1, wherein step (E) is automatically executed by the remote server in real-time.

7. The method of job recruiting between an employer network and a jobseeker network, the method as claimed in claim 1 comprises the steps of:
providing a set of interview criteria;
prompting the specific employer account through the corresponding employer local computer to select and to interview a desired jobseeker account from the pre-qualified accounts;
prompting the specific employer account through the corresponding employer local computer to input a score for each interview criteria for the specific employer account;
enabling the remote server to compile an overall interview score by averaging the score of each interview criteria;
receiving a set of interview comments from the specific employer account through the corresponding employer local computer;

8. The method of job recruiting between an employer network and a jobseeker network, the method as claimed in claim 7, wherein the interview criteria is selected from a group consisting of: appearance, bearing, expression, job knowledge, motivation, personality, and combinations thereof.

9. The method of job recruiting between an employer network and a jobseeker network, the method as claimed in claim 1 comprises the steps of:
providing an overall self-evaluation score, an essential duties evaluation score, an interview score for each pre-qualified accounts;
prompting the specific employer account through the corresponding employer local computer to view a desired jobseeker account from the pre-qualified accounts;
displaying the employment qualifications of the desired jobseeker account on a graphical summary interface through the corresponding employer local computer;
displaying the overall self-evaluation score and the essential duties evaluation score on the graphical summary interface through the corresponding employer local computer;

10. The method of job recruiting between an employer network and a jobseeker network, the method as claimed in claim 1 comprises the steps of:
prompting the specific employer account through the corresponding employer local computer to change a desired jobseeker account from the pre-qualified accounts to a hired status for the arbitrary job posting;
enabling the remote server to contextually update the candidate profile of the desired jobseeker account with the employment requirements of the arbitrary job posting,
if the desired jobseeker account is changed to the hired status;

11. The method of job recruiting between an employer network and a jobseeker network, the method as claimed in claim 1 comprises the steps of:
enabling the remote server to proportionately charge a monthly fee to each employer account based on a total number of job postings generated by each employer account;
